(19) United States
(12) Patent Application Publication
(10) Pub. No.: US 2026/0350317 A1
(43) Pub. Date: Nov. 5, 2026

(54) AI-POWERED NEWS AGGREGATION AND PERSONALIZATION SYSTEM

(71) Applicant: Degensoft Ltd, Dubai (AE)

(72) Inventor: Sergej Kunz, Dubai (AE)

(21) Appl. No.: 19/664,692

(22) Filed: Apr. 30, 2026

Related U.S. Application Data
(60) Provisional application No. 63/797,841, filed on Apr. 30, 2025.

(51) Int. Cl. G06F 40/30; G06F 40/169; G06F 40/205; G06F 40/295; G06F 40/40; H04L 51/02

(52) U.S. Cl. CPC G06F 40/30; G06F 40/169; G06F 40/205; G06F 40/295; G06F 40/40; H04L 51/02

(57) ABSTRACT

A news aggregation and personalization system comprising a global news aggregation engine configured to collect news articles from multiple sources, an AI-based content consolidation system configured to process the collected news articles to identify related articles and generate unified summaries, a dynamic user interface generation system configured to create displays for the unified summaries, and a personalized news delivery system configured to deliver customized news content to users based on their preferences. The system aggregates news using various methods, merges related articles, generates summaries and preview images, and provides personalized content delivery through a messaging bot and mobile applications with social functionality.

### PRIORITY

This application claims priority to U.S. Application No. 63/797,841, titled AI-POWERED NEWS AGGREGATION AND PERSONALIZATION SYSTEM, filed Apr. 30, 2025, which is hereby incorporated by reference in its entirety.

Any and all applications for which a foreign or domestic priority claim is identified in the Application Data Sheet as filed with the present application are hereby incorporated by reference under 37 C.F.R. § 1.57.

### FIELD

The present disclosure relates to news aggregation and personalization systems.

### BACKGROUND

In recent years, the digital landscape has undergone rapid transformation, leading to a proliferation of news sources and distribution channels. This expansion has created challenges for consumers seeking to stay informed about current events and topics of interest. The traditional model of relying on a handful of established news outlets has given way to a more complex ecosystem encompassing social media platforms, blogs, podcasts, and various other digital media formats. As the volume of available information continues to grow, individuals face increasing difficulty in efficiently discovering, tracking, and digesting relevant news content. The process of identifying trustworthy sources, staying abreast of emerging platforms, and managing multiple information streams can be time-consuming and overwhelming for many users.

Existing news aggregation services have attempted to address some of these challenges by consolidating content from multiple sources. However, these platforms often lack advanced personalization capabilities and may not fully leverage the potential of artificial intelligence in content curation and summarization. Additionally, the social aspect of news consumption, which allows users to connect over shared interests and engage in discussions, is frequently underutilized in current offerings. As the pace of information dissemination accelerates and the boundaries between traditional and digital media continue to blur, there is a growing need for innovative solutions that can help users navigate the complex news landscape. Such solutions should ideally combine comprehensive content aggregation, intelligent personalization, and community engagement features to provide a more streamlined and enriching news consumption experience.

Furthermore, the increasing prevalence of artificial intelligence and machine learning technologies presents opportunities to enhance the way news is collected, analyzed, and presented to users. These technologies have the potential to improve content relevance, generate concise summaries, and identify emerging trends across diverse information sources. As users become more discerning and time-constrained, there is a demand for tools that can not only aggregate news but also provide meaningful insights and facilitate deeper understanding of complex topics. This includes the ability to track specific subjects over time, receive customized updates, and engage with like-minded individuals in discussions about current events.

In light of these developments, it is evident that the field of news aggregation and personalization is ripe for innovation. Addressing the challenges of information overload, content discovery, and user engagement could lead to improved news consumption experiences for individuals across various demographics and interest areas.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an AI-powered news aggregation and summarization platform is provided. The platform includes a global news aggregation engine that aggregates news articles from sources worldwide using RSS feeds, FIDZ feeds, website sitemaps, and rich data embedded in news pages. The platform also includes an AI-based content consolidation system that processes collected data to identify news articles covering the same topic across various sources, merge them into a single unified post or summary, and cite and link to the original sources. The platform further includes a dynamic user interface generation system that automatically generates titles, summaries, and preview images for each news post, with optional buttons to expand into full-length AI-generated articles based on source material.

According to other aspects of the present disclosure, the platform may include one or more of the following features. The platform may include a personalized news delivery system with a dedicated Telegram bot that allows users to subscribe to topics, provide feedback, and receive a personalized feed of relevant, trending news recaps. The platform may also include mobile applications with social functionality, allowing users to like, repost, and comment on news items, make their customized news profiles public for others to follow or copy, annotate or highlight parts of the news, and generate short posts that can be aggregated as part of the trend-detection engine. The platform may further offer a commercial API service allowing third-party apps, publishers, and developers to integrate curated and summarized news feeds directly into their systems.

According to an aspect of the present disclosure, a system for aggregating and consolidating news content from heterogeneous sources is provided. The system includes one or more processors configured to execute computational instructions and one or more non-transitory computer-readable media operatively coupled to the one or more processors. The one or more non-transitory computer-readable media store executable instructions that, when executed by the one or more processors, cause the system to perform operations. The operations include aggregating a plurality of news content data, each news content data obtained from a plurality of geographically distributed news sources using a plurality of collection methods. The operations further include parsing one or more data structures associated with each news content data to extract metadata comprising at least a publication timestamp and content text. The operations further include processing the plurality of news content data using one or more machine learning models, wherein processing includes applying natural language processing to extract one or more semantic features from the extracted metadata, the semantic features comprising at least one of a topic identifier, named entity, or event descriptor. Processing further includes computing a similarity metric between each of the extracted semantic features across the plurality of news content data, identifying, based on the similarity metrics exceeding a predetermined threshold, a subset of the plurality of news content data that is associated with a similar topic, and generating a unified summary comprising a plurality of elements synthesized from the metadata of the subset of news content data, wherein the unified summary comprises source attribution for each element of the plurality of elements. The operations further include generating a display data structure comprising the unified summary, the display data structure comprising a programmatically generated title derived from the unified summary, a summary text, and a preview image selected from one or more images of the subset of news content data, the selection based on relevance scoring of the one or more images against the plurality of elements of the unified summary.

According to other aspects of the present disclosure, the plurality of collection methods may comprise at least two of RSS feeds, FIDZ feeds, website sitemaps, and structured metadata embedded within news pages. The source attribution may comprise one or more citation objects comprising hyperlinks to original source uniform resource locators and source identifier metadata for each element of the plurality of elements. The system may detect at least one conflicting fact between two or more news content data within the subset by comparing content text from each news content data of the subset and may encode the detected conflicting fact within the unified summary.

According to another aspect of the present disclosure, the system may deliver customized news content to a user based on user preference data stored in association with a user account identifier. Delivering the customized news content may comprise receiving, via a messaging bot interface operating through a messaging application programming interface, a subscription request message from the user specifying one or more topic identifiers, receiving feedback signals from the user regarding delivered news content, and updating personalization model parameters based on the feedback signals to adjust subsequent news content selection for the user.

According to another aspect of the present disclosure, a computer-implemented method for aggregating and consolidating news content from heterogeneous sources is provided. The method includes aggregating, by a computer system comprising a processor and a memory, a plurality of news content data from a plurality of geographically distributed news sources using a plurality of collection methods. The method further includes parsing one or more data structures associated with each news content data to extract metadata comprising at least a publication timestamp and content text. The method further includes processing the plurality of news content data using one or more machine learning models to extract semantic features and compute similarity metrics to identify a subset of news content data associated with a similar topic. The method further includes generating a unified summary comprising a plurality of elements synthesized from the metadata of the subset of news content data with source attribution for each element. The method further includes generating a display data structure comprising the unified summary, a programmatically generated title, a summary text, and a preview image selected based on relevance scoring.

According to another aspect of the present disclosure, a non-transitory computer-readable medium storing executable instructions is provided. When executed by one or more processors, the instructions cause the one or more processors to perform operations for aggregating and consolidating news content from heterogeneous sources. The operations include aggregating a plurality of news content data from a plurality of geographically distributed news sources, parsing data structures to extract metadata, processing the news content data using machine learning models to identify a subset associated with a similar topic, generating a unified summary with source attribution, and generating a display data structure comprising the unified summary, a programmatically generated title, a summary text, and a preview image selected based on relevance scoring.

The foregoing general description of the illustrative embodiments and the following detailed description thereof are merely exemplary aspects of the teachings of this disclosure and are not restrictive.

### BRIEF DESCRIPTION OF THE DRAWINGS

Detailed descriptions of implementations of the present invention will be described and explained through the use of the accompanying drawings.

FIG. 1 is a system diagram illustrating an example of a computing environment in which the disclosed system operates in some implementations of the present technology.

FIG. 2 is a system diagram illustrating an example of a computing environment in which the disclosed system operates in some implementations.

FIG. 3 is a block diagram that illustrates an example of a computer system in which at least some operations described herein can be implemented.

FIG. 4 is an example system diagram illustrating a news aggregation system according to some implementations herein.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The digital landscape has undergone rapid transformation, leading to a proliferation of news sources and distribution channels. The traditional model of relying on a handful of established news outlets has given way to a more complex ecosystem encompassing social media platforms, blogs, podcasts, and various other digital media formats. As the volume of available information continues to grow, individuals face increasing difficulty in efficiently discovering, tracking, and digesting relevant news content. The process of identifying trustworthy sources, staying abreast of emerging platforms, and managing multiple information streams can be time-consuming and overwhelming for many users.

Existing news aggregation services have attempted to address some of these challenges by consolidating content from multiple sources. However, these platforms often lack advanced personalization capabilities and do not fully leverage the potential of artificial intelligence in content curation and summarization. Additionally, the social aspect of news consumption, which allows users to connect over shared interests and engage in discussions, is frequently underutilized in current offerings.

The present disclosure describes an AI-powered news aggregation and personalization system that addresses these technical challenges. The system may collect, analyze, and deliver news content from various sources across the globe. In some implementations, the system may utilize artificial intelligence to process and summarize news articles, identify trends, and provide personalized content to users. The system may comprise multiple components to deliver a comprehensive news experience. These components may comprise a news aggregation engine, content consolidation algorithms, dynamic user interface generation, personalized news delivery mechanisms, and social functionality features, among others. In some implementations, the system may aggregate news from diverse sources, including but not limited to traditional news websites, social media platforms, and specialized content providers. The aggregated content may then be processed using one or more AI algorithms to identify related articles, merge information, and generate concise summaries.

In some implementations, the system may comprise one or more personalization features that allow users to specify their interests and preferences. Based on these user-defined parameters, the system may curate and deliver relevant news content. In some implementations, the system may also incorporate machine learning (ML) to continuously refine and improve the personalization process over time. Additionally, the system may include social features that enable users to interact with news content and connect with other users who share similar interests. The AI-powered news aggregation and personalization system may be accessible through various platforms, including web interfaces, mobile applications, and messaging services, among others.

### COMPUTER SYSTEM

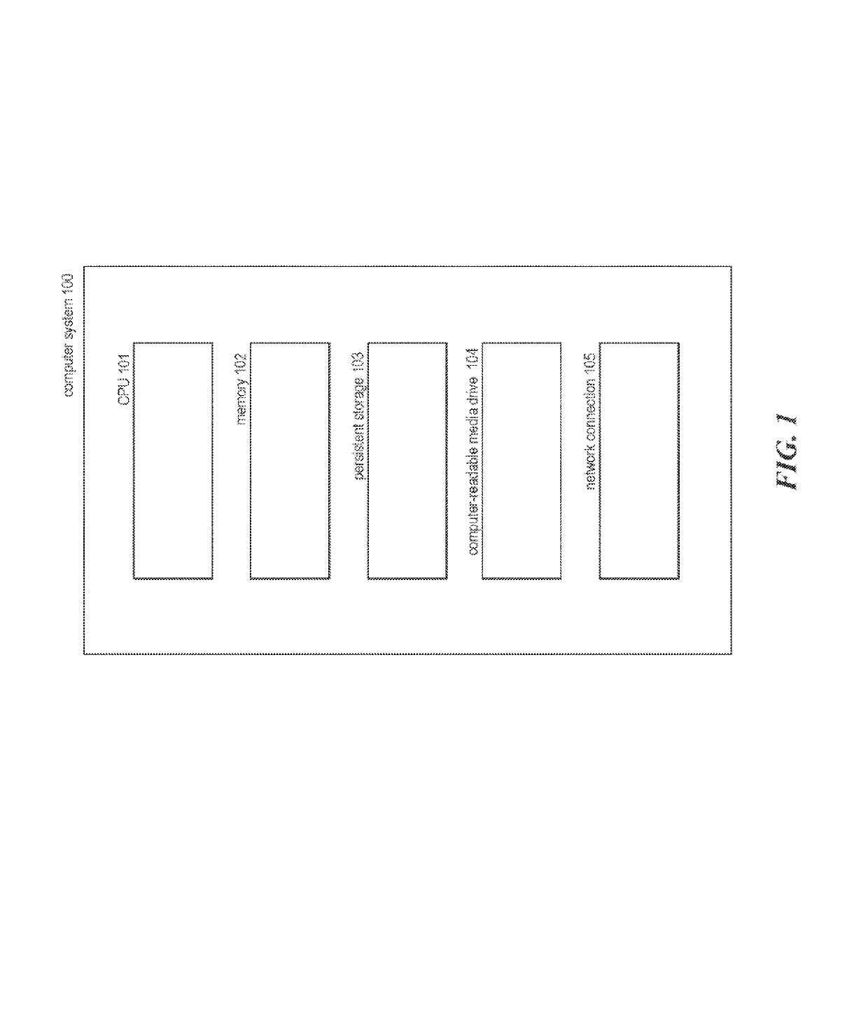

FIG. 1 is a block diagram showing some of the components typically incorporated in at least some of the computer systems and other devices on which the disclosed system operates. In various embodiments, these computer systems, and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (CPU) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; computer-readable media drives 104 that are tangible storage means that do not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations and having various components.

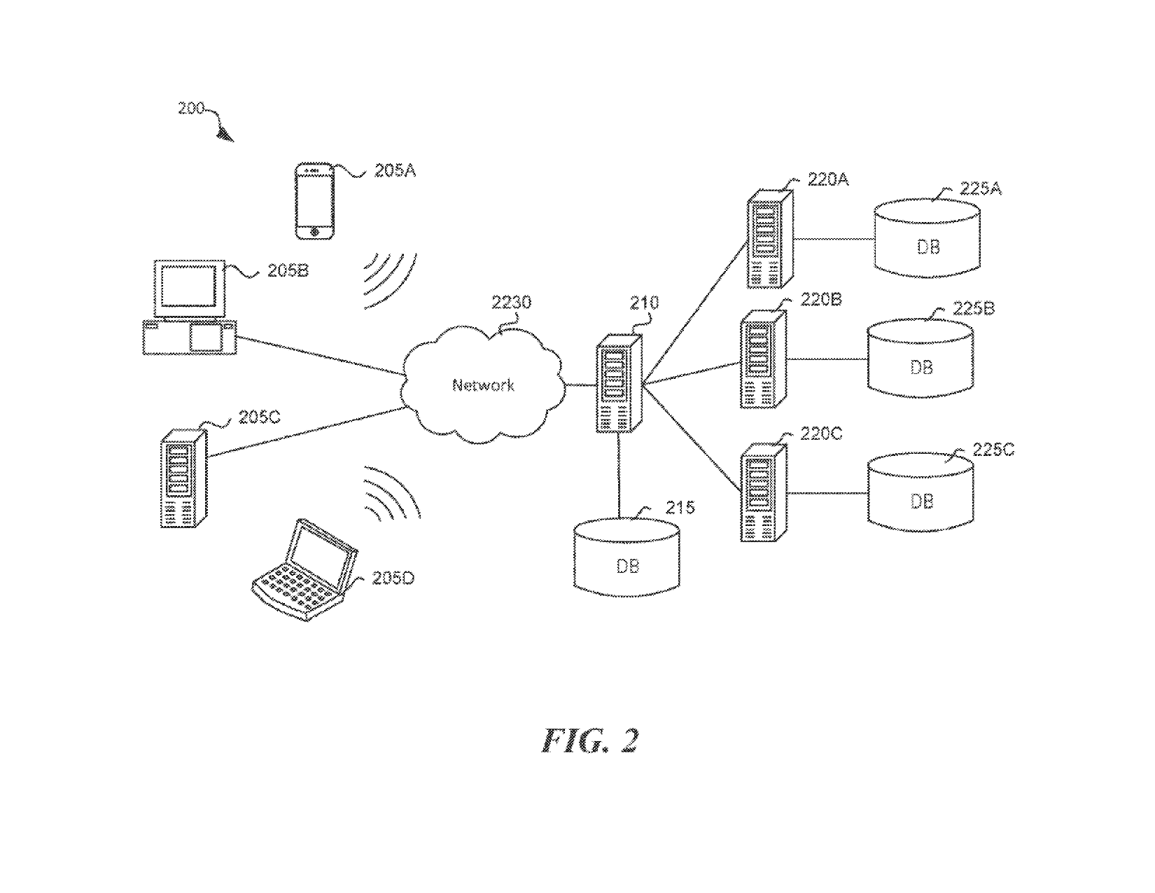

FIG. 2 is a system diagram illustrating an example of a computing environment in which the disclosed system operates in some embodiments. In some embodiments, environment 200 includes one or more client computing devices 205A-D, examples of which can host the system 100. Client computing devices 205 operate in a networked environment using logical connections through network 230 to one or more remote computers, such as a server computing device.

In some embodiments, server 210 is an edge server which receives client requests and coordinates fulfillment of those requests through other servers, such as servers 220A-C. In some embodiments, server computing devices 210 and 220 comprise computing systems, such as the system 100. Though each server computing device 210 and 220 is displayed logically as a single server, server computing devices can each be a distributed computing environment encompassing multiple computing devices located at the same or at geographically disparate physical locations. In some embodiments, each server 220 corresponds to a group of servers.

Client computing devices 205 and server computing devices 210 and 220 can each act as a server or client to other server or client devices. In some embodiments, servers (210, 220A-C) connect to a corresponding database (215, 225A-C). As discussed above, each server 220 can correspond to a group of servers, and each of these servers can share a database or can have its own database. Databases 215 and 225 warehouse (e.g., store) information such as home information, recent sales, home attributes, and so on. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN) but can also be other wired or wireless networks. In some embodiments, network 230 is the Internet or some other public or private network. Client computing devices 205 are connected to network 230 through a network interface, such as by wired or wireless communication. While the connections between server 210 and servers 220 are shown as separate connections, these connections can be any kind of local, wide area, wired, or wireless network, including network 230 or a separate public or private network.

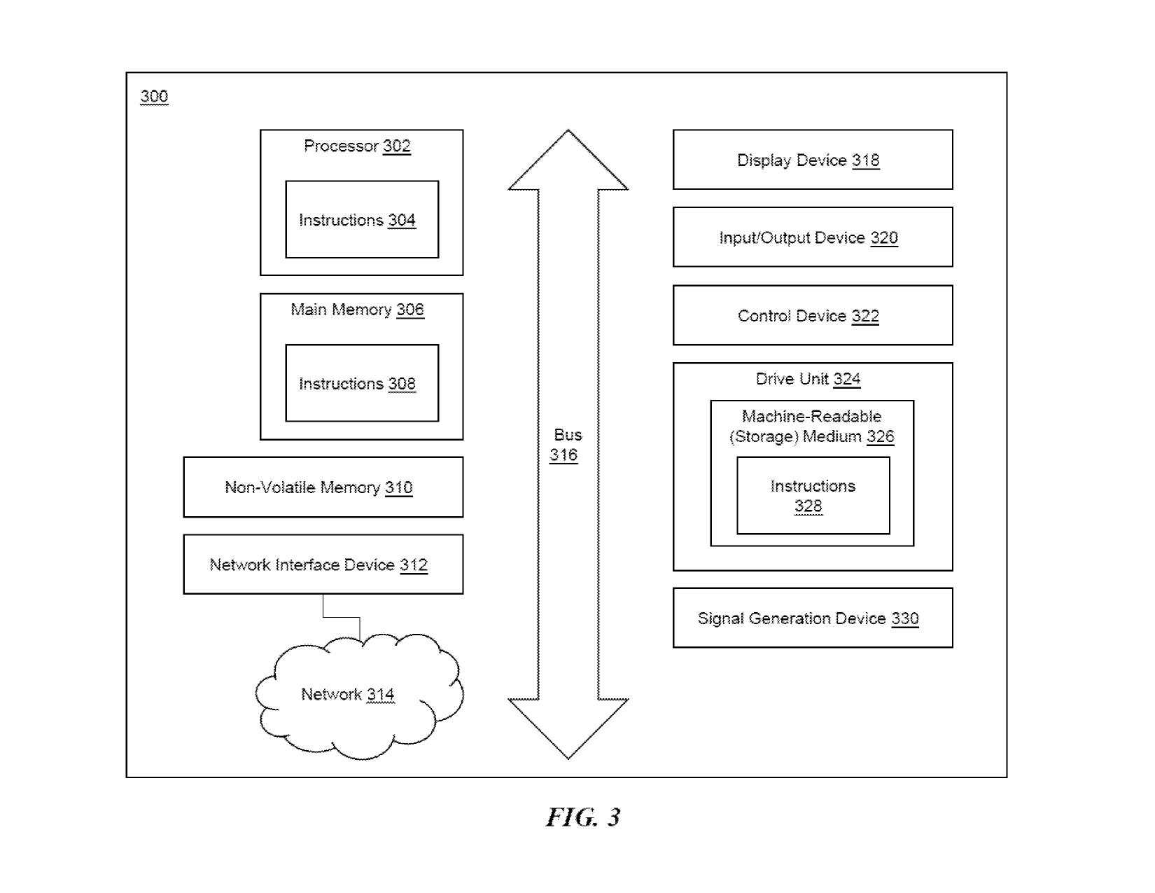

FIG. 3 is a block diagram that illustrates an example of a computer system 300 in which at least some operations described herein can be implemented. As shown, the computer system 300 can include: one or more processors 302, main memory 306, non-volatile memory 310, a network interface device 312, a video display device 318, an input/output device 320, a control device 322 (e.g., keyboard and pointing device), a drive unit 324 that includes a machine-readable (storage) medium 326, and a signal generation device 330 that are communicatively connected to a bus 316. The bus 316 represents one or more physical buses and/or point-to-point connections that are connected by appropriate bridges, adapters, or controllers. Various common components (e.g., cache memory) are omitted from FIG. 3 for brevity. Instead, the computer system 300 is intended to illustrate a hardware device on which components illustrated or described relative to the examples of the figures and any other components described in this specification can be implemented.

The computer system 300 can take any suitable physical form. For example, the computing system 300 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 300. In some implementations, the computer system 300 can be an embedded computer system, a system-on-chip (SOC), a single-board computer system (SBC), or a distributed system such as a mesh of computer systems, or it can include one or more cloud components in one or more networks. Where appropriate, one or more computer systems 300 can perform operations in real time, in near real time, or in batch mode.

The network interface device 312 enables the computing system 300 to mediate data in a network 314 with an entity that is external to the computing system 300 through any communication protocol supported by the computing system 300 and the external entity. Examples of the network interface device 312 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 306, non-volatile memory 310, machine-readable medium 326) can be local, remote, or distributed. Although shown as a single medium, the machine-readable medium 326 can include multiple media (e.g., a centralized/distributed database and/or associated caches and servers) that store one or more sets of instructions 328. The machine-readable medium 326 can include any medium that is capable of storing, encoding, or carrying a set of instructions for execution by the computing system 300. The machine-readable medium 326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 304, 308, 328) set at various times in various memory and storage devices in computing device(s). When read and executed by the processor 302, the instruction(s) cause the computing system 300 to perform operations to execute elements involving the various aspects of the disclosure.

### AI/ML

The AI-powered news aggregation and personalization system may employ various artificial intelligence and machine learning techniques to process, analyze, and deliver news content. In some implementations, the system may utilize supervised learning models trained on labeled datasets to perform classification tasks, such as categorizing news articles by topic or identifying named entities within article text. The supervised learning models may include neural network architectures, support vector machines, decision trees, random forests, or ensemble methods that combine multiple classifiers to improve prediction accuracy.

In some implementations, the system may employ unsupervised learning techniques to discover patterns and structures within news content without relying on labeled training data. Unsupervised learning techniques may include clustering algorithms that group similar news articles based on semantic similarity, dimensionality reduction methods that project high-dimensional text representations into lower-dimensional spaces for efficient processing, and topic modeling algorithms that identify latent themes across collections of news articles. The unsupervised learning techniques may enable the system to identify emerging topics and trends that were not anticipated during model training.

The machine learning models employed by the system may utilize various neural network architectures depending on the specific task being performed. In some implementations, the system may employ recurrent neural networks (RNNs), long short-term memory (LSTM) networks, or gated recurrent units (GRUs) for processing sequential text data. The system may also employ transformer-based architectures that utilize attention mechanisms to capture relationships between words and phrases across varying distances within text. Convolutional neural networks (CNNs) may be employed for tasks involving image analysis, such as selecting or generating preview images for news posts.

In some implementations, the system may utilize pre-trained language models that have been trained on large corpora of text data to learn general representations of language. The pre-trained language models may be fine-tuned on domain-specific datasets related to news content to improve performance on tasks such as summarization, entity extraction, and topic classification. Transfer learning techniques may enable the system to leverage knowledge captured in pre-trained models while adapting to the specific characteristics of news content.

The natural language processing techniques employed by the system may include tokenization, part-of-speech tagging, dependency parsing, named entity recognition, coreference resolution, and sentiment analysis. In some implementations, the system may employ word embedding techniques that represent words as dense vectors in a continuous vector space, where semantically similar words are mapped to nearby points. The word embeddings may be generated using techniques such as Word2Vec, GloVe, or contextual embeddings derived from transformer-based models. Sentence and document embeddings may be computed by aggregating word-level representations or by using models specifically designed to generate sentence-level or document-level representations.

The text summarization algorithms employed by the system may include extractive summarization techniques that select and concatenate salient sentences from source documents, as well as abstractive summarization techniques that generate novel text that captures the meaning of source documents. In some implementations, extractive summarization may employ scoring functions that evaluate sentence importance based on factors such as term frequency, position within the document, and similarity to the document as a whole. Abstractive summarization may employ sequence-to-sequence neural network architectures with encoder-decoder structures that learn to generate summary text conditioned on input document representations.

In some implementations, the machine learning models may be trained using various optimization algorithms and training procedures. The training process may involve minimizing loss functions that measure the discrepancy between model predictions and ground truth labels. Optimization algorithms such as stochastic gradient descent, Adam, or other adaptive learning rate methods may be employed to update model parameters during training. The training process may incorporate regularization techniques such as dropout, weight decay, or early stopping to prevent overfitting and improve generalization to unseen data.

The system may employ reinforcement learning techniques in some implementations to optimize content delivery and personalization. Reinforcement learning may enable the system to learn policies for selecting and ranking news content based on feedback signals derived from user interactions. The reinforcement learning framework may model the personalization task as a sequential decision-making problem where the system selects content to present to users and receives reward signals based on user engagement metrics.

In some implementations, the machine learning models may be deployed using various inference optimization techniques to reduce latency and computational resource requirements. Model compression techniques such as quantization, pruning, or knowledge distillation may be employed to reduce model size while maintaining prediction accuracy. The system may utilize hardware acceleration through graphics processing units (GPUs), tensor processing units (TPUs), or other specialized hardware to accelerate model inference operations.

### INTRODUCTION

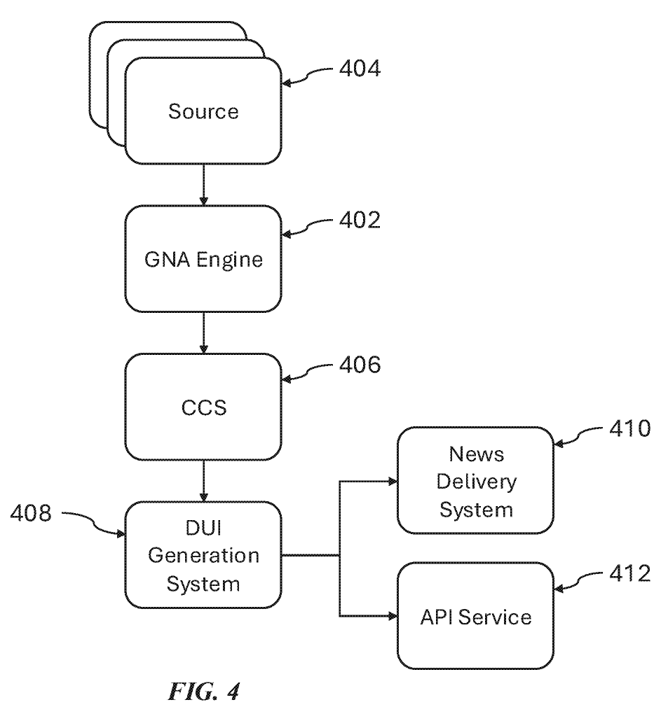

In some implementations, as shown in FIG. 4, a global news aggregation (GNA) engine 402 may collect news articles from a plurality of sources 404 worldwide using several methods. In some implementations, the engine 402 may utilize RSS (Really Simple Syndication) feeds to gather content from websites that offer this standardized format for distributing regularly updated information. The engine 402 may also employ FIDZ (Flexible Information Distribution Zone) feeds, which may provide a more versatile and customizable approach to content distribution compared to traditional RSS feeds. The engine 402 may further utilize website sitemaps to discover and index news articles and may extract rich data embedded within news pages, including structured metadata that provides additional context such as publication date, author, and topic categories, among others.

In some implementations, the AI-based content consolidation system (CCS) 406 may process collected data to identify and merge news articles covering the same topic from various sources. In some implementations, the system 406 may employ artificial intelligence and machine learning (AI/ML) models designed to analyze and compare the content of different news articles. The AI/ML models may utilize natural language processing (NLP) techniques to extract information from each article, such as the main topic, entities, and events. The system 406 may also compare these extracted elements across multiple articles to determine if the articles are covering the same news story or topic. Based on this analysis, the system 406 may generate a unified post or summary that incorporates information from all grouped articles and may include citations and links to the original sources within the unified post or summary.

In some implementations, a dynamic user interface (DUI) generation system 408 may create an informative display for each news post. In some implementations, the system 408 may automatically generate titles, summaries, and preview images to provide users with a quick overview of the news content. The system 408 may employ NLP to identify salient information and craft titles that represent the content. The system 408 may also use AI-powered text summarization algorithms to distill information from the consolidated content into concise paragraphs. In some implementations, the user interface may comprise mechanisms to expand into full-length AI-generated articles based on source material.

In some implementations, a personalized news delivery system 410 may include a dedicated Telegram bot designed to provide users with customized news content. In some implementations, users may subscribe to specific topics of interest through the Telegram bot and may provide feedback on the news content received. Based on user subscriptions and feedback, the personalized news delivery system 410 may generate a customized feed of relevant, trending news recaps for each user. The system 410 may incorporate ML algorithms to analyze user behavior and preferences, considering factors such as the types of news stories a user frequently engages with, the times of day the user is most active, and the depth of content the user prefers.

In some implementations, a commercial API service 412 may allow third-party applications, publishers, and developers to integrate curated and summarized news feeds directly into their own systems. In some implementations, the API 412 may offer various endpoints for different types of news content and functionalities, such as endpoints for retrieving trending news topics, accessing summarized articles on specific subjects, or obtaining personalized news recommendations based on user preferences.

The integrated system may provide several technical advantages relative to existing news aggregation solutions. By employing AI-based content consolidation, the system may improve content relevance through automated identification of related articles across multiple sources and generation of unified summaries that draw from diverse perspectives. This consolidation approach may reduce information redundancy and provide users with more comprehensive overviews of news topics compared to systems that present individual articles from separate sources without merging related content.

The system may provide efficient summarization of multiple sources into unified posts through the use of NLP and AI-powered text summarization algorithms. This approach may enable users to quickly understand news topics without reading multiple separate articles covering the same story. The dynamic user interface generation system may further enhance efficiency by automatically generating titles, summaries, and preview images that provide quick overviews of news content.

The personalized delivery mechanisms may adapt to user behavior over time through the use of ML algorithms that analyze user interactions and preferences. In some implementations, the system may continuously adjust and refine the news content delivered to each user based on factors such as engagement patterns, active times, and content depth preferences. This adaptive personalization may improve the relevance of delivered content compared to static subscription-based systems that do not learn from user behavior.

Cross-platform integration of the system may enable seamless functionality across web interfaces, mobile applications, and messaging services. A user may set up preferences through one platform and receive personalized content through another, with the system maintaining consistency across channels. The social functionality features may contribute to trend-detection capabilities by aggregating user-generated content and engagement signals, which may help identify emerging news topics.

### SYSTEM COMPONENTS

In some implementations, the global news aggregation engine may collect news articles from a variety of sources worldwide using multiple methods. The global news aggregation engine may be configured to handle various data formats and structures, enabling the system to aggregate news from a wide range of publishers, from large international news organizations to smaller, specialized news outlets. In some implementations, the global news aggregation engine may utilize RSS (Really Simple Syndication) feeds to gather content from websites that offer this standardized format for distributing regularly updated information. RSS feeds may provide a structured approach to content retrieval, allowing the engine to receive notifications when new articles are published and to retrieve article metadata in a consistent format. The engine may parse RSS feed data to extract article titles, publication dates, content summaries, and links to full articles.

The global news aggregation engine may also employ FIDZ (Flexible Information Distribution Zone) feeds. FIDZ feeds may provide a more versatile and customizable approach to content distribution compared to traditional RSS feeds. In some implementations, FIDZ feeds may support additional metadata fields, custom content categorization schemes, and more granular control over content delivery parameters. The engine may leverage these capabilities to obtain richer information about news articles during the aggregation process. In addition to feed-based collection methods, the global news aggregation engine may leverage website sitemaps to discover and index news articles. These sitemaps may be structured according to standards used by search engine indexing systems. In some implementations, the engine may parse sitemap files to identify URLs of news articles, along with associated metadata such as last modification dates and update frequencies. The sitemap-based discovery technique may enable the engine to identify news content from sources that do not provide RSS or FIDZ feeds, or to supplement feed-based collection with additional article discovery.

The global news aggregation engine may extract data embedded within news pages. This data may include structured metadata that provides additional context about news articles, such as publication date, author, and topic categories, among others. In some implementations, the engine may parse embedded metadata formats to extract information that may not be available through feed-based or sitemap-based methods.

In some implementations, the global news aggregation engine may employ a combination of these methods to provide comprehensive coverage of news sources. For example, the engine may first check for available RSS or FIDZ feeds from a particular news outlet. If such feeds are not available or do not provide complete coverage, the engine may then resort to crawling the website's sitemap or extracting rich data from individual news pages.

To maintain up-to-date information, the global news aggregation engine may operate on a continuous basis, regularly checking sources for new content. The frequency of these checks may be adjusted based on factors such as the typical publication rate of each source and the overall volume of news being processed by the system. In some implementations, the engine may also incorporate error handling and retry mechanisms to deal with temporary unavailability of news sources or network issues. In some implementations, the global news aggregation engine may employ a hierarchical feed fallback mechanism to provide comprehensive coverage of news sources. The global news aggregation engine may first check for available RSS (Really Simple Syndication) or FIDZ (Flexible Information Distribution Zone) feeds from a particular news outlet. If such feeds are not available or do not provide complete coverage of the news outlet's content, the global news aggregation engine may then resort to crawling the website's sitemap to discover and index news articles. In cases where sitemap-based discovery is also insufficient or unavailable, the global news aggregation engine may extract rich data from individual news pages. This hierarchical approach may enable the global news aggregation engine to aggregate news from a wide range of publishers, including sources that do not offer standardized feed formats.

In some implementations, the global news aggregation engine may incorporate error handling and retry mechanisms to deal with temporary unavailability of news sources or network issues. When a news source becomes temporarily inaccessible, the global news aggregation engine may queue the source for subsequent retry attempts rather than abandoning the collection process. The retry mechanisms may employ configurable parameters such as retry intervals and maximum retry counts, among others. These error handling mechanisms may help ensure that the news collection process remains robust and reliable, even in the face of potential disruptions such as server outages, network latency, or intermittent connectivity issues.

In some implementations, the AI-based content consolidation system may employ artificial intelligence and machine learning (AI/ML) models to analyze and compare the content of different news articles collected by the global news aggregation engine. In some implementations, the AI/ML models may utilize natural language processing (NLP) techniques to extract information from each article. The extracted information may include the main topic of the article, entities mentioned within the article (such as people, organizations, locations, and products), and events described in the article. The NLP techniques may parse the textual content of each article to identify and categorize these elements.

In some implementations, the AI-based content consolidation system may compare the extracted elements across multiple articles to determine whether the articles are covering the same news story or topic. The comparison process may involve analyzing similarities in the identified topics, overlapping entities, and related events. Based on this comparison, the system may identify clusters of articles that pertain to the same underlying news story. The content consolidation process may involve grouping articles that have been identified as covering the same topic. Once articles are grouped, the AI/ML models may analyze the content of each article within the group. This analysis may identify unique pieces of information that appear in some articles but not others, corroborating details that are reported consistently across multiple sources, and any conflicting reports where different sources provide contradictory information.

In some implementations, the system may weigh the information from different sources based on factors such as source reliability, publication timing, and consistency with other reports. The system may flag discrepancies or conflicting information found across different sources and may present these differences in a manner that allows users to understand the varying perspectives.

Based on the analysis of grouped articles, the AI-based content consolidation system may generate a unified post or summary that incorporates information from all the grouped articles. The unified post or summary may provide a comprehensive overview of the topic, drawing from multiple sources to present a more complete picture of the news story. In some implementations, the unified post or summary may synthesize the corroborating details while noting any conflicting reports. To maintain transparency and allow for fact-checking, the AI-based content consolidation system may include citations and links to the original sources within the unified post or summary. Each piece of information in the summary may be linked to the original source from which the information was obtained. This citation mechanism may allow users to trace information back to the original articles and verify the accuracy of the consolidated content.

The AI-based content consolidation system may be configured to handle a wide range of news topics, including politics, economics, technology, entertainment, and other subject areas. By consolidating information from diverse sources, the system may provide users with a more comprehensive and efficient way to stay informed about current events.

In some implementations, the AI-based content consolidation system may employ ML algorithms to improve the ability of the AI-based content consolidation system to identify related articles and generate accurate summaries over time. The ML algorithms may learn from user feedback and engagement metrics to refine consolidation techniques used by the AI-based content consolidation system. For example, when users frequently expand summaries to read original sources on certain topics, the AI-based content consolidation system may adjust the level of detail provided in future summaries for similar topics. The ML algorithms may analyze patterns in user interactions, such as click-through rates on consolidated summaries, time spent reading expanded content, and user ratings of summary quality. Based on this analysis, the ML algorithms may modify parameters used in the article grouping and summary generation processes.

In some implementations, the ML algorithms may track correlations between summary characteristics and user engagement outcomes. The ML algorithms may identify which summary lengths, vocabulary choices, and structural formats correlate with higher user satisfaction for different topic categories. The AI-based content consolidation system may then apply these learned preferences when generating new consolidated content. The learning process may operate continuously, allowing the AI-based content consolidation system to adapt to changing user preferences and evolving news consumption patterns.

The AI-based content consolidation system may highlight discrepancies or conflicting information found across different sources. In some implementations, when the AI/ML models analyze grouped articles covering the same topic, the AI/ML models may identify instances where different sources provide contradictory information. The AI-based content consolidation system may present these differences in a clear and unbiased manner within the unified post or summary. For example, if one source reports a particular statistic while another source reports a different value for the same metric, the AI-based content consolidation system may display both values along with attributions to the respective sources.

In some implementations, the discrepancy highlighting mechanism may categorize conflicts based on the type of information involved. Categories may include factual discrepancies (such as differing numerical data or dates), interpretive differences (such as varying analyses of the same event), and source attribution conflicts (such as disagreements about the origin of a statement or action). The AI-based content consolidation system may present each category of discrepancy using distinct visual indicators or textual markers, allowing users to quickly identify the nature of the conflicting information.

The presentation of conflicting information may maintain neutrality by avoiding language that favors one source over another. In some implementations, the AI-based content consolidation system may display conflicting reports in a side-by-side format or in sequential statements that give equal weight to each source. The AI-based content consolidation system may comprise citations and links to the original sources for each conflicting piece of information, enabling users to access the primary materials and form independent assessments.

A dynamic user interface generation system may create an informative display for each news post. The dynamic user interface generation system may automatically generate elements of the interface, including titles, summaries, and preview images, to provide users with a quick overview of news content. In some implementations, the dynamic user interface generation system may analyze consolidated news content to extract or generate an appropriate title for each post. The dynamic user interface generation system may employ natural language processing (NLP) techniques to identify salient information within the consolidated content. Based on the identified salient information, the dynamic user interface generation system may craft a title that accurately represents the content of the news post. The NLP techniques may parse textual content to determine topics, entities, and events that characterize the news story. The dynamic user interface generation system may then synthesize this information to generate a title that captures the substance of the news story in a concise manner.

The dynamic user interface generation system may also create brief summaries for each news post. In some implementations, the dynamic user interface generation system may use AI-powered text summarization algorithms to distill information from the consolidated content into a concise paragraph. The text summarization algorithms may analyze the consolidated content to identify points and details that characterize the news story. The algorithms may then generate a summary that conveys these points without requiring users to read the full article. The summary generation process may consider factors such as information density, readability, and coherence when producing the output text.

Preview images may be automatically selected or generated by the dynamic user interface generation system to accompany each news post. In some implementations, the dynamic user interface generation system may select preview images based on relevance to the news content, visual appeal, and potential to engage users. The dynamic user interface generation system may analyze multiple images associated with the original news sources and select an image that corresponds to the subject matter of the consolidated content. The selection process may evaluate image characteristics such as resolution, composition, and subject matter alignment with the news topic.

In some implementations, the dynamic user interface generation system may generate composite images or infographics based on the content of the news story. The composite image generation process may combine visual elements from multiple sources or create graphical representations of data and information contained within the news content. Infographics may be generated to visually represent statistical information, timelines, or relationships between entities mentioned in the news story.

The user interface may comprise optional buttons to expand into full-length AI-generated articles based on source material. These buttons may allow users to access more detailed information if they wish to explore a topic further. When a user activates this option, the dynamic user interface generation system may generate a comprehensive article by combining and expanding upon information from multiple source articles. In some implementations, the dynamic user interface generation system may adapt output based on user preferences or device characteristics. The dynamic user interface generation system may adjust the length of summaries or the size of preview images to suit different screen sizes or user reading preferences. The dynamic user interface generation system may also incorporate interactive elements within the user interface. These interactive elements may include options for users to rate the relevance or quality of the news post, share the content on social media platforms, or save articles for later reading, among others. For example, when a user accesses the system through a device with a smaller screen, the dynamic user interface generation system may generate shorter summaries that fit within the available display area without excessive scrolling. Conversely, when a user accesses the system through a device with a larger screen, the dynamic user interface generation system may generate longer summaries that provide additional detail. The dynamic user interface generation system may also adjust the size of preview images based on device characteristics. Preview images displayed on devices with smaller screens may be scaled to appropriate dimensions that maintain visual clarity while conserving screen space. Preview images displayed on devices with larger screens or higher resolution displays may be rendered at larger sizes to take advantage of the available display area.

User reading preferences may influence the output generated by the dynamic user interface generation system. In some implementations, users may specify preferences for summary length, such as brief, standard, or detailed summaries. The dynamic user interface generation system may store these preferences and apply the preferences when generating content for the corresponding user. The dynamic user interface generation system may also detect device characteristics automatically, such as screen dimensions, resolution, and orientation, and may adjust output parameters accordingly.

The user interface may incorporate interactive elements that enable users to engage with news content. In some implementations, the user interface may include options for users to rate the relevance or quality of news posts. Users may provide ratings through mechanisms such as star ratings, thumbs-up or thumbs-down indicators, or numerical scales. The ratings provided by users may be collected and processed by the system to refine personalization algorithms and improve content recommendations for the corresponding user and other users with similar preferences.

These adaptive and interactive features may address the technical challenge of delivering optimized content presentation across diverse devices and usage contexts. By adjusting output parameters based on device characteristics, the dynamic user interface generation system may provide content that is appropriately formatted for each device type. By incorporating interactive elements, the user interface may enable users to engage with content in ways that enhance the news consumption experience and provide feedback that improves system performance over time.

The personalized news delivery system may include a dedicated messaging bot designed to provide users with customized news content. In some implementations, the messaging bot may operate through various messaging platforms, including but not limited to Telegram, WhatsApp, Facebook Messenger, Slack, Discord, WeChat, Signal, or other messaging applications that support bot integrations or automated messaging interfaces. The messaging bot may communicate with users through messaging application programming interfaces (APIs) provided by the respective messaging platforms.

In some implementations, the messaging bot may be platform-agnostic, with a core messaging engine that interfaces with multiple messaging platform APIs through platform-specific adapters or connectors. The platform-specific adapters may translate commands and responses between a standardized internal format and the native formats required by each messaging platform. This architecture may allow the personalized news delivery system to extend support to additional messaging platforms without requiring substantial modifications to the core messaging functionality.

The messaging bot may support various interaction modalities depending on the capabilities of the underlying messaging platform. In some implementations, the messaging bot may receive text-based commands, voice messages, reaction indicators such as emoji responses, inline button selections, or other input mechanisms supported by the messaging platform. The messaging bot may deliver news content through text messages, rich media cards, interactive message components, or other presentation formats available on the respective messaging platform.

Users may subscribe to specific topics of interest through the messaging bot regardless of the underlying messaging platform. The personalized news delivery system may maintain user subscription data and preference information in a platform-independent manner, allowing users to access consistent personalized news experiences across different messaging platforms associated with the same user account.

The personalized news delivery system may include a dedicated bot, such as a Telegram bot, designed to provide users with customized news content. The Telegram bot may allow users to interact with the news aggregation and summarization platform through the Telegram messaging application.

In some implementations, users may subscribe to specific topics of interest through the Telegram bot. The Telegram bot may support topic subscription commands that allow users to specify categories of news content the users wish to receive. For example, a user interested in technology news may send a command to the Telegram bot such as "/subscribe technology" to begin receiving updates on that topic. The personalized news delivery system may support a range of topics, allowing users to tailor news feeds to individual interests. Users may subscribe to multiple topics by sending additional subscription commands, and the personalized news delivery system may aggregate content from all subscribed topics into a unified personalized feed.

The Telegram bot may provide mechanisms for users to offer feedback on the news content the users receive. In some implementations, users may use simple commands or reactions to indicate whether the users like or dislike a particular news item. For instance, a user may respond to a news summary with a thumbs-up or thumbs-down emoji to express an opinion regarding the news item. The personalized news delivery system may collect and process this emoji feedback to refine and improve the personalization of the user's news feed over time. The feedback mechanism may enable the personalized news delivery system to learn user preferences without requiring users to navigate complex settings or provide detailed input.

In some implementations, the Telegram bot may support more complex interactions beyond simple subscription commands and emoji feedback. Users may request summaries on specific topics or ask questions about current events through natural language queries. The Telegram bot may utilize natural language processing (NLP) capabilities to interpret these requests and provide appropriate responses. For example, a user may send a message asking for a summary of recent developments in a particular industry, and the Telegram bot may analyze the request using NLP techniques to identify the topic of interest and generate a relevant response based on aggregated news content.

The NLP capabilities may enable the Telegram bot to parse user queries, extract topic identifiers and temporal references, and match the extracted information against available news content. In some implementations, the Telegram bot may handle ambiguous or multi-faceted queries by requesting clarification from the user or by providing responses that address multiple interpretations of the query.

Based on user subscriptions and feedback, the personalized news delivery system may generate a customized feed of relevant, trending news recaps for each user. These recaps may be delivered through the Telegram bot at regular intervals or in real-time as news events occur. The personalized news delivery system may incorporate machine learning (ML) algorithms to analyze user behavior and preferences. The ML algorithms may consider factors such as the types of news stories a user frequently engages with, the times of day the user is most active, and the depth of content the user prefers. Based on this analysis, the personalized news delivery system may continuously adjust and refine the news content delivered to each user.

In some implementations, the Telegram bot may offer additional features to enhance the user experience. These features may include the ability to save articles for later reading, share news items with other Telegram users, or set up alerts for breaking news on specific topics. The personalized news delivery system and Telegram bot may be designed to handle a large number of users simultaneously, such that each user receives timely and relevant news updates.

The personalized news delivery system may incorporate machine learning (ML) algorithms to analyze user behavior and preferences. In some implementations, the ML algorithms may consider factors such as the types of news stories a user frequently engages with, the times of day the user is most active, and the depth of content the user prefers. The ML algorithms may track user interactions with news content, including which articles a user reads, how long the user spends reading each article, and which topics the user selects for further exploration. Based on this behavioral analysis, the personalized news delivery system may continuously adjust and refine the news content delivered to each user.

In some implementations, the ML algorithms may identify patterns in user engagement over time. For example, the ML algorithms may determine that a particular user tends to engage with longer, more detailed articles during evening hours while preferring shorter summaries during morning commutes. The personalized news delivery system may use these identified patterns to adjust the format and timing of news delivery for the corresponding user. The ML algorithms may also analyze the correlation between user engagement and specific content characteristics, such as article length, topic complexity, and source diversity.

The Telegram bot may offer additional features to enhance the user experience. In some implementations, the Telegram bot may provide the ability for users to save articles for later reading. When a user saves an article, the personalized news delivery system may store a reference to the saved article in association with the user account. Users may access saved articles through commands sent to the Telegram bot, allowing users to retrieve and read saved content at a later time.

The Telegram bot may enable users to share news items with other Telegram users. In some implementations, users may forward news summaries or articles to individual contacts or groups within the Telegram messaging application. The sharing functionality may include options to share the original summary, a link to the full article, or a customized message that includes selected excerpts from the news content.

The Telegram bot may support the setup of alerts for breaking news on specific topics. In some implementations, users may configure alert preferences by specifying topics of interest and notification thresholds. When news events occur that match the configured alert criteria, the personalized news delivery system may send notifications to the corresponding users through the Telegram bot. The alert system may allow users to specify the urgency level of news events that trigger notifications, enabling users to receive immediate alerts for high-priority topics while receiving periodic digests for lower-priority subjects.

The personalized news delivery system and Telegram bot may be designed to handle a large number of users simultaneously. In some implementations, the personalized news delivery system may employ scalable infrastructure to manage the processing and delivery of personalized content efficiently. The scalable infrastructure may include distributed computing resources that can be allocated dynamically based on user demand and system load.

The scalable infrastructure may incorporate load balancing mechanisms to distribute processing tasks across multiple computing nodes. In some implementations, the personalized news delivery system may utilize message queuing systems to manage the flow of news content and user requests. The message queuing systems may buffer incoming requests during periods of high demand and distribute the requests to available processing resources. The scalable infrastructure may also include caching mechanisms to store frequently accessed content and reduce redundant processing operations.

In some implementations, the personalized news delivery system may employ horizontal scaling techniques to accommodate increases in user volume. When user demand exceeds the capacity of existing computing resources, the scalable infrastructure may provision additional computing nodes to handle the increased load. The horizontal scaling approach may allow the personalized news delivery system to maintain consistent performance levels as the number of users grows. The scalable infrastructure may also incorporate monitoring and alerting systems to detect performance degradation and trigger automatic scaling operations when predefined thresholds are exceeded.

The mobile applications may be designed for various mobile platforms, such as iOS and Android devices. The mobile applications may provide users with a convenient way to access and interact with news content on smartphones or tablets. In some implementations, the mobile applications may be configured to operate on different operating system versions and device form factors, adapting the user interface and functionality to the characteristics of each platform.

The mobile applications may provide tools for users to annotate or highlight parts of news articles. In some implementations, the annotation tools may enable users to mark sections of news articles that the users find noteworthy or relevant. Users may select portions of text within a news article and apply visual indicators, such as highlighting, to distinguish the selected portions from surrounding content. The annotation tools may support multiple highlight colors or styles, allowing users to categorize annotations according to user-defined criteria.

The mobile applications may provide tools for users to add personal notes to news articles. In some implementations, users may attach text-based notes to specific locations within a news article. These notes may contain user observations, questions, or supplementary information related to the news content. The notes may be stored in association with the corresponding news article and user account, allowing users to retrieve and review the notes at a later time.

The annotation tools may enable users to emphasize points within news content. In some implementations, users may apply formatting or visual markers to draw attention to particular statements, data points, or quotations within a news article. The emphasis functionality may allow users to identify and revisit content that the users consider relevant to their interests or research.

In some implementations, users may be able to share annotations with others. The annotation sharing capability may allow users to distribute annotated versions of news articles to other users of the mobile applications. When a user shares annotations, the recipient may view the news article with the shared annotations displayed, providing additional context or insights to the news stories. The annotation sharing functionality may support sharing with individual users or with groups of users who have similar interests.

The shared annotations may include highlights, notes, and emphasis markers created by the sharing user. In some implementations, recipients of shared annotations may have the option to save the shared annotations to their own accounts, add additional annotations, or respond to the annotations with comments. The annotation sharing capability may facilitate collaborative analysis of news content among users with shared interests or within professional or educational contexts.

The mobile applications may include user-generated content features that enable users to create and share content within the platform. In some implementations, users may create short posts similar in format to tweets. These user-generated posts may contain text, links to news articles, or commentary on current events. The short posts may be shared within the application, allowing other users to view and interact with the content. The user-generated posts may be aggregated as part of a trend-detection engine. The trend-detection engine may analyze the content and frequency of user-generated posts to identify emerging topics of interest or shifts in user attention toward particular news stories. By incorporating user-generated content into the trend-detection process, the system may supplement automated news aggregation with signals derived from user activity and engagement.

In some implementations, the mobile applications may include features that allow users to create and share custom news digests. Users may compile a selection of news articles on a specific topic or theme into a curated collection. The custom news digest may include articles from various sources that the user has selected based on relevance, quality, or personal interest. Users may organize the selected articles within the digest according to user-defined criteria, such as chronological order, source type, or subtopic. Once compiled, users may share the custom news digest with other users of the mobile applications. Recipients of shared news digests may view the curated collection and access the included articles.

The mobile applications may incorporate gamification elements to encourage user engagement with news content. In some implementations, users may earn points for performing various activities within the application. Activities that may result in point accumulation include reading news articles, sharing articles with other users, and contributing comments on news content. The gamification system may track user activities and award points based on predefined criteria. For example, a user may earn a specified number of points for each article read or for each article shared with other users. In some implementations, users may earn badges for achieving particular milestones or demonstrating consistent engagement patterns. Badges may be awarded for activities such as consistently reading news over a period of time, sharing a threshold number of articles, or contributing thoughtful comments that receive positive responses from other users. The badges may be displayed on user profiles, providing visual indicators of user engagement and participation within the application.

The mobile applications may include collaborative features that allow users to work together on news-related projects. In some implementations, users may create collaborative news timelines where multiple users can contribute articles and annotations to build a comprehensive overview of a developing story or long-term trend. The collaborative news timelines may enable users to collectively compile news content related to a particular topic, event, or theme over a period of time. Each contributing user may add articles from the aggregated news content to the collaborative timeline, along with annotations that provide context, analysis, or commentary on the added articles. In some implementations, the collaborative news timelines may include version tracking capabilities that record contributions from each participating user. The version tracking may allow users to view the history of additions and modifications made to the collaborative timeline. Users may have the ability to organize contributed articles within the timeline according to chronological order, subtopic, or other user-defined criteria. The collaborative features may support permission settings that allow timeline creators to control whether the timeline is open for contributions from any user or restricted to invited participants.

The mobile applications may provide integration with external social media platforms. In some implementations, the integration may allow users to share news content or curated collections on other social networks. Users may select individual news articles, consolidated summaries, or custom news digests and share the selected content to external social media platforms through sharing interfaces provided by the mobile applications. In some implementations, the external social integration may format shared content according to the requirements of each destination social media platform. The formatting may include generating appropriate preview text, selecting or generating preview images, and creating links that direct recipients back to the full content within the mobile applications. Users may add personal commentary or context when sharing content to external social media platforms.

The collaborative features and external social integration may address the technical problem of enabling community engagement and cross-platform content distribution. By providing collaborative news timelines, the mobile applications may enable groups of users to collectively track and analyze news topics in ways that individual users working separately may not achieve. The collaborative approach may aggregate diverse perspectives and sources of information contributed by multiple users into unified timeline views. The external social integration may extend the distribution of news content beyond the boundaries of the mobile applications, allowing users to share curated and summarized news content with audiences on other social networks. The cross-platform content distribution may increase the reach of news content processed by the system and may enable users to leverage existing social connections on external platforms when sharing news-related content.

The AI-powered news aggregation and personalization system may offer a commercial API service that allows third-party applications, publishers, and developers to integrate curated and summarized news feeds directly into their own systems. The commercial API service may provide a programmatic interface for accessing aggregated, consolidated, and personalized news content generated by the platform.

In some implementations, the commercial API service may offer various endpoints for different types of news content and functionalities. The endpoints may include endpoints for retrieving trending news topics, which may provide third-party applications with access to topics that are receiving increased attention across aggregated news sources. The commercial API service may also include endpoints for accessing summarized articles on specific subjects, allowing developers to retrieve consolidated content related to particular topics or categories of interest. Additionally, the commercial API service may provide endpoints for obtaining personalized news recommendations based on user preferences, enabling third-party applications to deliver customized news content to their users.

The commercial API service may support multiple authentication methods to provide secure access to news content. In some implementations, developers may obtain API keys that serve as credentials for authenticating requests to the commercial API service. The API keys may be associated with developer accounts and may be used to track usage and enforce access controls. The commercial API service may also support OAuth 2.0 for authentication and authorization. OAuth 2.0 may enable third-party applications to obtain limited access to the commercial API service on behalf of users without requiring users to share their credentials directly with the third-party applications. The OAuth 2.0 implementation may support various grant types to accommodate different application architectures and security requirements.

The commercial API service may provide flexible options for data retrieval. In some implementations, developers may specify parameters when making requests to the commercial API service to tailor the returned content to their specific requirements. The parameters may include the number of articles to retrieve, allowing developers to control the volume of content returned in each response. Developers may also specify date ranges to retrieve news content published within particular time periods. The commercial API service may accept parameters for specific topics or categories, enabling developers to filter content based on subject matter. Additionally, developers may specify preferred languages to retrieve news content in languages appropriate for their user base.

The commercial API service may offer real-time streaming capabilities that enable third-party applications to receive instant updates on breaking news or trending topics. In some implementations, the real-time streaming capabilities may establish persistent connections between the commercial API service and third-party applications, allowing news updates to be pushed to connected applications as news events occur rather than requiring applications to periodically request new content. The real-time streaming capabilities may address the technical problem of delivering timely news information to integrated systems without polling delays. In traditional polling-based approaches, third-party applications may send periodic requests to an API service to check for new content. This polling approach may introduce latency between the occurrence of a news event and the delivery of corresponding content to the third-party application. The latency may depend on the polling interval configured by the third-party application, with shorter intervals increasing server load and longer intervals increasing delivery delays. The real-time streaming capabilities may reduce or eliminate this latency by enabling the commercial API service to push news updates to connected applications when the updates become available.

In some implementations, the real-time streaming capabilities may support multiple streaming protocols to accommodate different application architectures and network environments. The commercial API service may provide WebSocket connections that maintain bidirectional communication channels between the commercial API service and third-party applications. Through these WebSocket connections, the commercial API service may transmit news updates to connected applications without requiring the applications to initiate individual requests for each update. The real-time streaming capabilities may support topic-based subscriptions that allow third-party applications to specify categories of news content for which the applications wish to receive streaming updates. When a third-party application establishes a streaming connection, the application may provide subscription parameters indicating topics, geographic regions, or other content filters. The commercial API service may then transmit updates that match the specified subscription parameters through the established streaming connection.

In some implementations, the real-time streaming capabilities may incorporate mechanisms for handling connection interruptions and reconnection scenarios. When a streaming connection is interrupted due to network issues or other factors, the commercial API service may buffer updates that would have been transmitted during the interruption period. Upon reconnection, the commercial API service may transmit the buffered updates to the third-party application, allowing the application to receive news content that was generated during the disconnection period. The real-time streaming capabilities may support configurable delivery parameters that allow third-party applications to control the volume and frequency of streaming updates. In some implementations, third-party applications may specify rate limits that cap the number of updates transmitted within a given time period. Third-party applications may also specify content thresholds that filter streaming updates based on factors such as topic relevance scores or source diversity metrics.

The commercial API service may support a variety of use cases that enable third-party applications, publishers, and developers to leverage the news aggregation and personalization capabilities of the platform.

In some implementations, the commercial API service may be used for news aggregation applications. Third-party developers may use the commercial API service to create news applications that leverage the content curation and summarization capabilities of the platform. These third-party news applications may retrieve aggregated and consolidated news content through the commercial API service and present the content to users through custom user interfaces designed by the third-party developers. The third-party news applications may access endpoints for trending news topics, summarized articles, and personalized recommendations, allowing the third-party developers to build news experiences tailored to specific audiences or use cases without implementing content aggregation and consolidation systems independently.

In some implementations, the commercial API service may be used for content recommendation systems. Publishers may integrate the commercial API service into websites or applications operated by the publishers to provide personalized news recommendations to users of the websites or applications. The content recommendation systems may utilize endpoints that return personalized news recommendations based on reading history and preferences. When a user accesses a publisher's website or application, the content recommendation system may send requests to the commercial API service that include parameters indicating the user's reading history and preference data. The commercial API service may process these parameters and return news content that corresponds to the user's interests. Publishers may display the recommended news content alongside other content on the websites or applications, providing users with relevant news suggestions based on past reading behavior.

In some implementations, the commercial API service may be used for business intelligence tools. Companies may use the commercial API service to monitor news related to industries in which the companies operate, competitors of the companies, or topics of interest to the companies. The business intelligence tools may integrate news content retrieved through the commercial API service into internal dashboards or reports used by the companies. The commercial API service may provide endpoints that allow the business intelligence tools to specify parameters such as industry categories, company names, or topic keywords. The commercial API service may return news articles and summaries that match the specified parameters. Companies may use the retrieved news content to track industry developments, monitor competitor activities, or identify trends relevant to business operations.

In some implementations, the commercial API service may be used for voice assistants. Developers of voice-activated devices or services may use the commercial API service to provide users with verbal news updates or summaries upon request. When a user issues a voice command requesting news information, the voice assistant may send a request to the commercial API service specifying parameters such as topic categories or the number of news items to retrieve. The commercial API service may return summarized news content in a format suitable for text-to-speech conversion. The voice assistant may then convert the returned summaries into spoken audio and deliver the verbal news updates to the user. The summarization capabilities of the platform may provide concise news content that is suitable for verbal delivery through voice-activated interfaces.

In some implementations, the commercial API service may be used for digital signage. Businesses may integrate the commercial API service into digital displays located in public spaces or office environments. The digital signage systems may retrieve current news headlines and summaries through the commercial API service and display the retrieved content on screens visible to individuals in the corresponding locations. The digital signage systems may send periodic requests to the commercial API service to retrieve updated news content, allowing the displayed information to remain current. Parameters specified in the requests may include topic categories relevant to the location or audience, such as business news for corporate office displays or local news for displays in public venues.

In some implementations, the commercial API service may be used for educational platforms. E-learning applications may incorporate the commercial API service to provide students with current events information relevant to studies undertaken by the students. The educational platforms may retrieve news content through the commercial API service and present the content within learning modules or as supplementary reading material. The commercial API service may provide endpoints that allow the educational platforms to specify subject areas or topics that correspond to curriculum content. The retrieved news articles and summaries may provide students with real-world examples and current information related to subjects being studied. Educational platforms may also use the retrieved news content to create news-based learning exercises or discussion prompts.

In some implementations, the commercial API service may be used for social media management tools. Social media managers may use the commercial API service to discover trending topics and relevant news content for sharing on various social platforms. The social media management tools may retrieve trending news topics and summarized articles through the commercial API service. Social media managers may review the retrieved content and select news items to share with audiences on social media platforms managed by the social media managers. The commercial API service may provide endpoints that return trending topics across various categories, allowing social media managers to identify content that may generate engagement from social media audiences. The summarization capabilities of the platform may provide concise content suitable for sharing on social media platforms where brevity is valued.

The AI-powered news aggregation and personalization system may support cross-platform functionality that enables users to access news content and associated user data across multiple platforms. In some implementations, a user may begin reading a news article on a mobile device, add annotations to the article, and later access the same article with the annotations on a web interface. The cross-platform functionality may synchronize user data, including annotations, highlights, and reading progress, across devices and platforms associated with a user account. In some implementations, the cross-platform synchronization may operate through a centralized data storage system that maintains user-specific data in association with user accounts. When a user adds an annotation to a news article on a mobile device, the annotation data may be transmitted to the centralized data storage system. The centralized data storage system may store the annotation data in association with identifiers for the user account and the corresponding news article. When the user subsequently accesses the same news article through a web interface, the web interface may retrieve the stored annotation data from the centralized data storage system and display the annotations within the article view.

The cross-platform synchronization may support various types of user data. In some implementations, the synchronized data may include text highlights applied to portions of news articles, personal notes attached to specific locations within articles, reading progress indicators that track how far a user has read within an article, and saved article references that allow users to access saved content across platforms. The synchronization process may operate in near real-time, allowing users to transition between devices with minimal delay in data availability.

The AI-powered news aggregation and personalization system may incorporate real-time updates for breaking news events. In some implementations, when a significant news event occurs, the global news aggregation engine may collect information from multiple sources at an accelerated rate. The global news aggregation engine may increase the frequency of source checks during periods when breaking news is detected, allowing the system to gather information from diverse sources as the news event develops.

The AI-based content consolidation system may process breaking news information through a rapid processing pathway. In some implementations, the rapid processing pathway may prioritize breaking news content for consolidation and summary generation. The AI-based content consolidation system may generate preliminary summaries based on initial source articles and may update the summaries as additional information becomes available from other sources. The rapid processing pathway may reduce the time between news event occurrence and delivery of consolidated content to users.

In some implementations, the system may push breaking news updates to users through preferred notification channels. The personalized news delivery system may transmit breaking news summaries to users through the Telegram bot, mobile application push notifications, or other configured notification mechanisms. The breaking news delivery may be filtered based on user subscription preferences, such that users receive breaking news updates for topics to which the users have subscribed.

The AI-powered news aggregation and personalization system may support advanced analytics capabilities that analyze user interactions across various components of the system. In some implementations, the analytics capabilities may collect data regarding user engagement with news content, including article views, reading duration, annotation activity, sharing behavior, and feedback responses. The analytics capabilities may aggregate interaction data across the web interface, mobile applications, Telegram bot, and other access channels associated with each user account.

The analytics capabilities may analyze the collected interaction data to identify news consumption patterns. In some implementations, the analysis may identify patterns such as preferred reading times, topic engagement trends, content format preferences, and source preferences for individual users. The analytics capabilities may also analyze aggregated data across multiple users to identify trending topics and emerging areas of user interest.

In some implementations, the analytics capabilities may generate insights regarding user preferences based on the identified patterns. The insights may include correlations between user demographics and content preferences, relationships between topic categories and engagement levels, and temporal patterns in news consumption behavior. The personalization algorithms may utilize the insights generated by the analytics capabilities to refine content recommendations and delivery timing for individual users.

The analytics capabilities may provide feedback loops that improve system performance over time. In some implementations, the analytics capabilities may track the effectiveness of personalization recommendations by measuring user engagement with recommended content. The analytics capabilities may identify which recommendation strategies correlate with higher user engagement and may adjust personalization parameters accordingly. The feedback loops may operate continuously, allowing the system to adapt to changes in user preferences and news consumption patterns.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system for aggregating and consolidating news content from heterogeneous sources, the system comprising:
one or more processors configured to execute computational instructions; and
one or more non-transitory computer-readable media operatively coupled to the one or more processors, the one or more non-transitory computer-readable media storing executable instructions that, when executed by the one or more processors, cause the system to perform operations comprising:
aggregating a plurality of news content data, each news content data of the plurality of news content data obtained from a plurality of geographically distributed news sources using a plurality of collection methods,
parsing one or more data structures associated with each news content data of the plurality of news content data to extract metadata comprising at least a publication timestamp and content text;
processing the plurality of news content data using one or more machine learning models, wherein processing comprises:
applying natural language processing to extract one or more semantic features from the extracted metadata from each news content data of the plurality of news content data, the semantic features comprising at least one of a topic identifier, named entity, and event descriptor;
computing a similarity metric between each of the extracted one or more semantic features across the plurality of news content data;
identifying, based on the similarity metrics exceeding a predetermined threshold, a subset of the plurality of news content data that is associated with a similar topic; and
generating a unified summary comprising a plurality of elements synthesized from the metadata of the subset of news content data, wherein the unified summary comprises source attribution for each element of the plurality of elements; and
generating a display data structure comprising the unified summary, the display data structure comprising a programmatically generated title derived from the unified summary, a summary text, and a preview image selected from one or more images of the subset of news content data, the selection based on relevance scoring of the one or more images against the plurality of elements of the unified summary.

2. The system of claim 1, wherein the plurality of collection methods comprises at least two of:
RSS feeds;
FIDZ feeds;
website sitemaps; and
structured metadata embedded within news pages.

3. The system of claim 1, wherein the source attribution comprises one or more citation objects comprising hyperlinks to original source uniform resource locators and source identifier metadata for each element of the plurality of elements.

4. The system of claim 1, wherein processing the plurality of news content data comprises:
extracting, using natural language processing comprising at least one of named entity recognition or topic modeling, information from each news content data, the information comprising at least one of a main topic vector representation, entity identifiers with associated entity types, or event descriptors with temporal markers; and
computing pairwise similarity scores between the extracted information across the plurality of news content data using vector space similarity measures.

5. The system of claim 1, wherein the operations further comprise:
detecting at least one conflicting fact between two or more news content data within the subset of news content data by comparing content text from each news content data of the subset; and
encoding the detected at least one conflicting fact within the unified summary.

6. The system of claim 1, wherein generating the display data structure comprises:
analyzing the unified summary using natural language processing comprising keyword extraction and salience scoring to identify the plurality of elements; and
synthesizing the programmatically generated title from the identified plurality of elements.

7. The system of claim 1, wherein the operations further comprise:
receiving, via an interactive user interface element of the display data structure, a user-initiated request to expand the unified summary; and
in response to the user-initiated request, generating an article based on content text from the news content data of the subset of news content data.

8. The system of claim 1, wherein the operations further comprise:
delivering customized news content to a user based on user preference data stored in association with a user account identifier, wherein the customized news content comprises the unified summary.

9. The system of claim 8, wherein delivering the customized news content comprises:
receiving, via a messaging bot interface operating through a messaging application programming interface, a subscription request message from the user specifying one or more topic identifiers;
receiving, via the messaging bot interface, feedback signals from the user regarding delivered news content; and
updating personalization model parameters based on the feedback signals to adjust subsequent news content selection for the user.

10. The system of claim 8, wherein delivering the customized news content comprises analyzing user behavioral data comprising at least one of:
topic category distributions of news content data with which the user engages;
temporal patterns indicating times of day during which the user is active; or
content length metrics indicating depth of content the user prefers.

11. The system of claim 1, wherein aggregating the plurality of news content data comprises employing a hierarchical fallback mechanism comprising:
checking for available RSS or FIDZ feed data from a news source of the plurality of geographically distributed news sources;
in response to determining that the RSS or FIDZ feed data is unavailable or provides incomplete coverage, parsing a website sitemap of the news source; and
in response to determining that the website sitemap is unavailable or yields insufficient content discovery, extracting structured metadata embedded within individual news pages of the news source.

12. The system of claim 1, wherein the operations further comprise:
providing, via a mobile application, social functionality features comprising at least one of:
receiving and storing user engagement signals comprising like indicators, repost requests, or comment text associated with news content data;
enabling users to configure visibility settings for customized news profile data structures; or
receiving and storing annotation data comprising text highlights or user-generated notes associated with news content data.

13. The system of claim 1, wherein the operations further comprise:
receiving user-generated post data objects from a user, each post data object comprising textual content and associated metadata; and
processing the user-generated post data objects using a trend-detection engine to identify at least one trending topic.

14. A computer-implemented method for aggregating and consolidating news content from heterogeneous sources, the method comprising:
aggregating, by a computer system, a plurality of news content data, each news content data of the plurality of news content data obtained from a plurality of geographically distributed news sources using a plurality of collection methods,
parsing, by the computer system, one or more data structures associated with each news content data of the plurality of news content data to extract metadata comprising at least a publication timestamp and content text;
processing, by the computer system, the plurality of news content data using one or more machine learning models, wherein processing comprises:
applying natural language processing to extract one or more semantic features from the extracted metadata from each news content data of the plurality of news content data, the semantic features comprising at least one of a topic identifier, named entity, and event descriptor;
computing a similarity metric between each of the extracted one or more semantic features across the plurality of news content data;
identifying, based on the similarity metrics exceeding a predetermined threshold, a subset of the plurality of news content data that is associated with a similar topic; and
generating a unified summary comprising a plurality of elements synthesized from the metadata of the subset of news content data, wherein the unified summary comprises source attribution for each element of the plurality of elements; and
generating, by the computer system, a display data structure comprising the unified summary, the display data structure comprising a programmatically generated title derived from the unified summary, a summary text, and a preview image selected from one or more images of the subset of news content data, the selection based on relevance scoring of the one or more images against the plurality of elements of the unified summary
wherein the computer system comprises a processor and a memory.

15. The method of claim 14, wherein aggregating the plurality of news content data comprises using at least two of:
RSS feeds;
FIDZ feeds;
website sitemaps; and
structured metadata embedded within news pages.

16. The method of claim 14, further comprising:
receiving, via a messaging bot interface operating through a messaging application programming interface, a subscription request message from a user specifying one or more topic identifiers; and
generating a customized feed data structure comprising news content filtered based on the specified topic identifiers.

17. The method of claim 14, further comprising:
collecting user interaction event data comprising at least one of content view events, reading duration measurements, or engagement signals associated with delivered news content;
processing a user interaction event data using machine learning algorithms to update personalization model parameters; and
selecting subsequent news content data for delivery to a user based on the updated personalization model parameters.

18. The method of claim 14, further comprising:
providing, via an application programming interface endpoint, programmatic access to the unified summary.

19. A non-transitory computer-readable medium storing executable instructions that, when executed by one or more processors, cause the one or more processors to perform operations for aggregating and consolidating news content from heterogeneous sources, the operations comprising:
aggregating a plurality of news content data, each news content data of the plurality of news content data obtained from a plurality of geographically distributed news sources using a plurality of collection methods,
parsing one or more data structures associated with each news content data of the plurality of news content data to extract metadata comprising at least a publication timestamp and content text;
processing the plurality of news content data using one or more machine learning models, wherein processing comprises:
applying natural language processing to extract one or more semantic features from the extracted metadata from each news content data of the plurality of news content data, the semantic features comprising at least one of a topic identifier, named entity, and event descriptor;
computing a similarity metric between each of the extracted one or more semantic features across the plurality of news content data;
identifying, based on the similarity metrics exceeding a predetermined threshold, a subset of the plurality of news content data that is associated with a similar topic; and
generating a unified summary comprising a plurality of elements synthesized from the metadata of the subset of news content data, wherein the unified summary comprises source attribution for each element of the plurality of elements; and
generating a display data structure comprising the unified summary, the display data structure comprising a programmatically generated title derived from the unified summary, a summary text, and a preview image selected from one or more images of the subset of news content data, the selection based on relevance scoring of the one or more images against the plurality of elements of the unified summary.

20. The non-transitory computer-readable medium of claim 19, wherein the operations further comprise:
receiving feedback signals from a user regarding delivered news content data;
processing the feedback signals using machine learning algorithms to compute updated personalization model parameters; and
selecting subsequent news content data for delivery to the user based on the updated personalization model parameters.
